(19) United States
(12) Patent Application Publication
(10) Pub. No.: US 2010/0242432 A1
(43) Pub. Date: Sep. 30, 2010

(54) ADJUSTABLE IGNITER MOUNT

(75) Inventor: Daniel J. Sullivan, Jupiter, FL (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: ALSTOM TECHNOLOGIES LTD. LLC, Baden (CH)

(21) Appl. No.: 12/409,805

(22) Filed: Mar. 24, 2009

(51) Int. Cl. F02C 7/266

(52) U.S. Cl. 60/39.827

(57) ABSTRACT

An ignition assembly for providing increased movement of an igniter within a combustor is provided. The ignition assembly includes a base assembly having a first base plate, a second base plate, and a positioning plate, where the positioning plate contains an igniter and is capable of adjusting in an axial and/or circumferential direction relative to the combustor.

### TECHNICAL FIELD

The present invention generally relates to an ignition system for a gas turbine combustor. More specifically, the ignition system includes a base capable of providing planar adjustment of an igniter position within a combustor.

### BACKGROUND OF THE INVENTION

Gas turbine engines operate to produce mechanical work or thrust. Specifically, land-based gas turbine engines typically have a generator coupled thereto for the purposes of generating electricity. A gas turbine engine comprises an inlet that directs air to a compressor section which has stages of rotating compressor blades spaced between stages of stationary vanes. As the air passes through the compressor, the pressure of the air increases. The compressed air is then directed into one or more combustors where fuel is injected into the compressed air and the mixture is ignited. The hot combustion gases are then directed from the combustion section to a turbine section. As the hot combustion gases pass through the turbine, the stages of the turbine rotate, which in turn, causes the compressor to rotate.

The fuel air mixture in the combustor is ignited by an ignition system. The ignition system comprises a spark igniter connected to a power source. The igniter extends through a combustor case and slightly into a combustor so as to provide a source of ignition for a fuel-air mixture within the combustor. The igniter is typically mounted to a plate or base component located along the combustor case. However, embodiments of the prior art igniter and plate have little capability to adjust the position of the igniter within the combustor.

Referring initially to FIG. 1, a cross section of an igniter assembly 100 in accordance with the prior art is depicted. One such prior igniter assembly 100 comprises a plurality of base plates 102 and 104. Extending through the base plates 102 and 104 is a ball joint 106 which permits an igniter 108 to pivot at the point of the ball joint 106. The igniter assembly 100 can be adjusted slightly within the combustor by pivoting the ball joint 106. However, movement of the igniter is limited to the rotational movement caused by the pivoting ball joint 106. As it can be seen in FIGS. 1 and 2, the igniter 108 extends into the combustor 110 through an opening 112. However, movement of the igniter 108 relative to the combustor 110 is limited. Excessive contact between the igniter 108 and combustor 110 can cause undesired wear on the combustor wall and/or the igniter.

### SUMMARY

In accordance with the present invention, there is provided a novel configuration for an ignition system and way for adjusting an igniter relative to a combustor. The ignition system provides a way in which an igniter location can be adjusted relative to a combustor.

In an embodiment of the present invention, an ignition assembly for a gas turbine combustor comprises a base assembly having a first base plate, a second base plate, a positioning plate, one or more sealing gaskets, and a first plurality of fasteners for securing the first base plate to the second base plate. The ignition system also comprises a second plurality of fasteners, an ignition source coupled to the positioning plate, and a power source coupled to the ignition source. The positioning plate is configured such that it can be repositioned to ensure that the ignition source does not contact a wall of the combustor.

In an alternate embodiment of the present invention, an adjustable igniter base is provided comprising a first base plate, a second base plate having a recessed portion and a positioning plate, one or more sealing gaskets, a first plurality of fasteners for securing the first base plate to the second base plate. The base plates are secured together such that the positioning plate is secured within the recessed portion after planar movement.

In yet another embodiment of the present invention, a method of adjusting an igniter relative to a combustor is disclosed. The method comprises placing an igniter through a positioning plate of a base assembly and into a combustor and then determining a first position of the igniter relative to the combustor. Fasteners which secure the first base plate to the second base plate can be loosened such that the positioning plate, which the igniter passes through, can be moved in an axial and/or circumferential direction to a second position. A determination is then made as to whether the second position of the igniter is satisfactory relative to the combustor. Once the igniter is in an acceptable position, the second base plate is fastened to the first base plate.

Additional advantages and features of the present invention will be set forth in part in a description which follows, and in part will become apparent to those skilled in the art upon examination of the following, or may be learned from practice of the invention. The instant invention will now be described with particular reference to the accompanying drawings.

### BRIEF DESCRIPTION OF THE SEVERAL VIEWS OF THE DRAWINGS

The present invention is described in detail below with reference to the attached drawing figures, wherein:

FIG. 1 is a cross section view of an igniter assembly of the prior art;

FIG. 2 is a exploded view of an igniter assembly of the prior art;

FIG. 3 is a perspective view of an igniter assembly in accordance with an embodiment of the present invention;

FIG. 4 is an exploded perspective view of an igniter assembly in accordance with an embodiment of the present invention;

FIG. 5 is a cross section view of an igniter assembly in accordance with an embodiment of the present invention;

FIG. 6A is a cross section view of the igniter assembly of FIG. 5 with a mounting plate in a first position;

FIG. 6B is a cross section view of the igniter assembly of FIG. 5 with the mounting plate in a second position; and,

FIG. 7 is an alternate cross section view of the second base plate of the igniter assembly of FIG. 5 in accordance with an embodiment of the present invention.

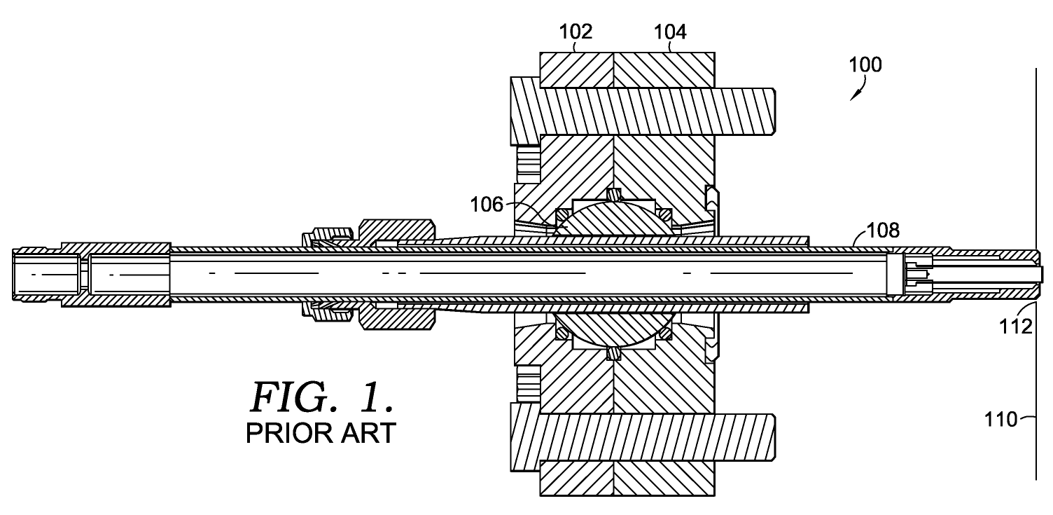

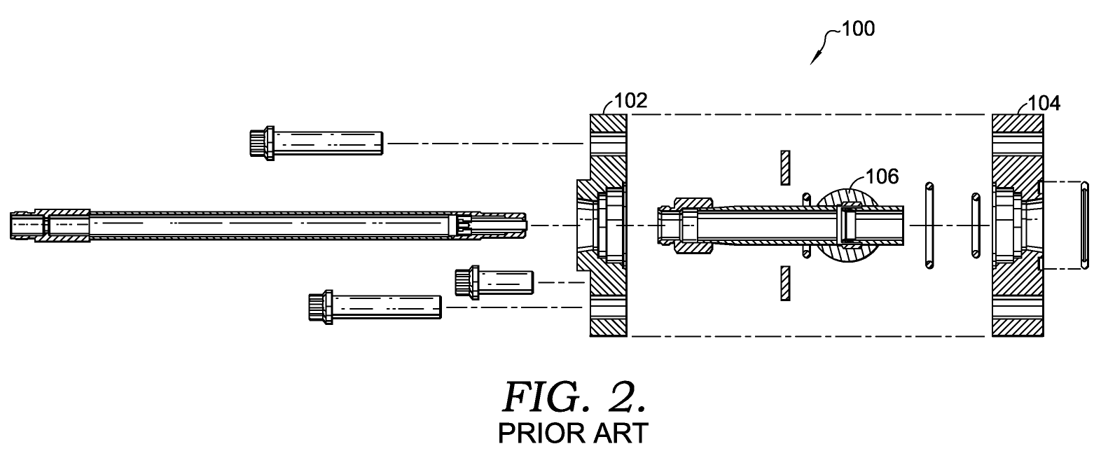

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different components, combinations of components, steps, or combinations of steps similar to the ones described in this document, in conjunction with other present or future technologies.

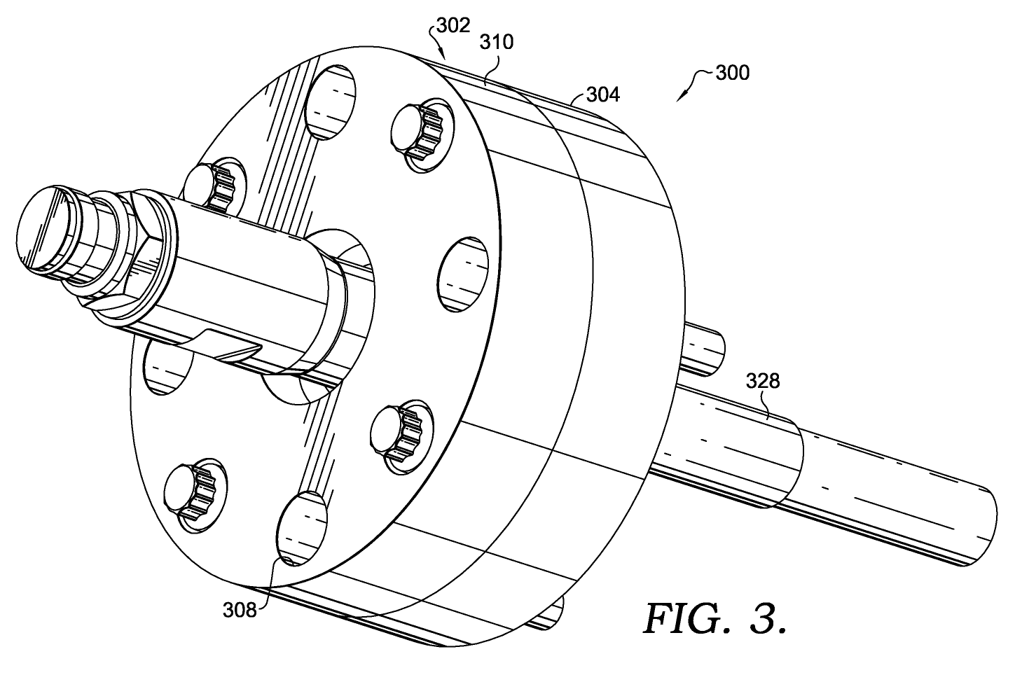

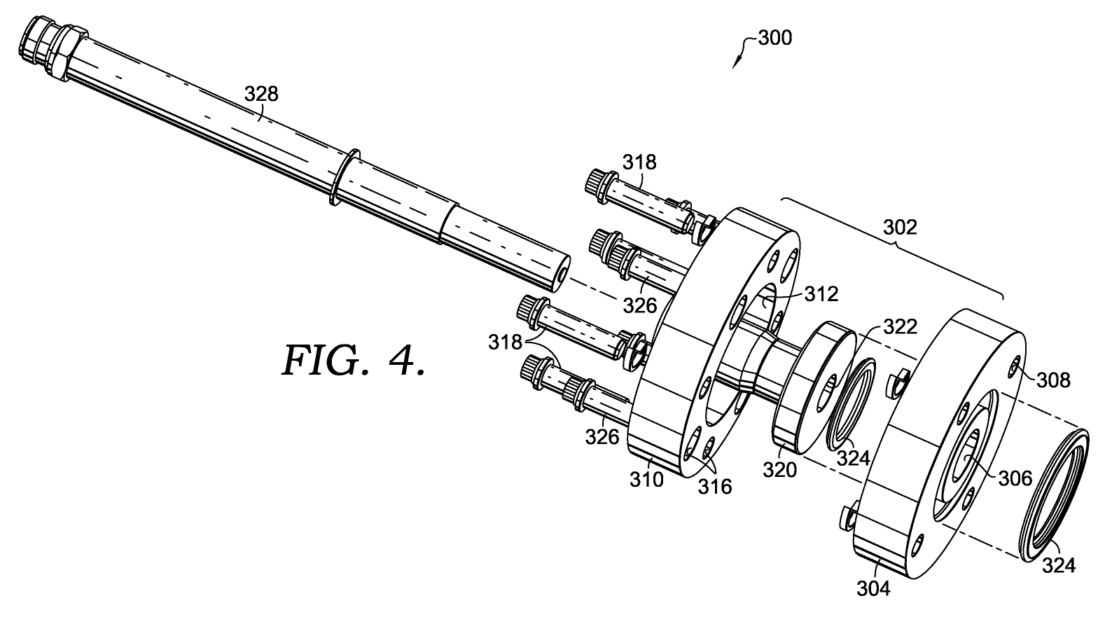

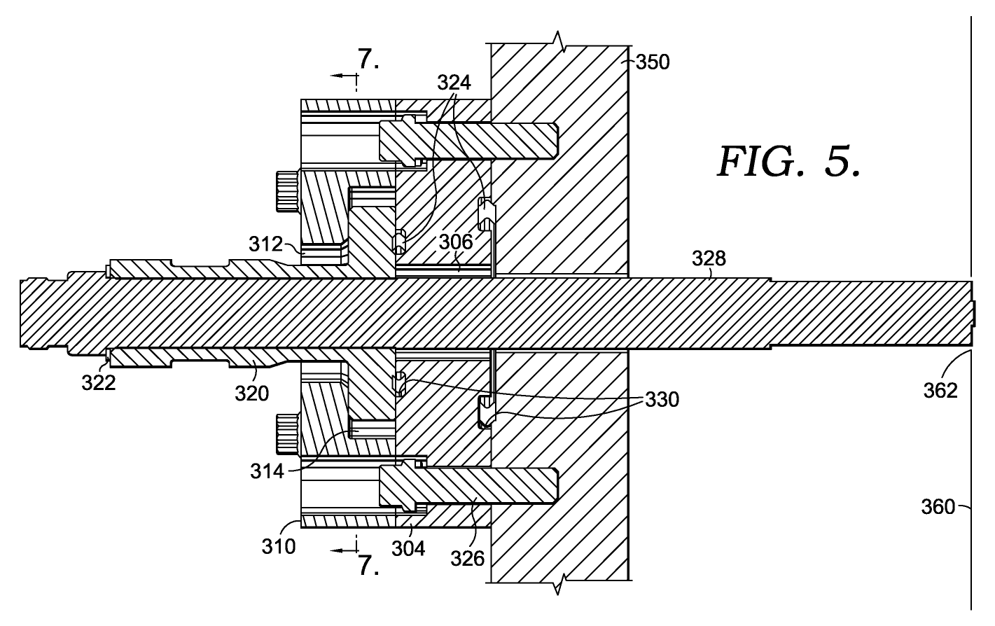

Referring to FIGS. 3 and 4, an embodiment of the present invention is shown in detail. The ignition system 300 comprises a base assembly 302 having a first base plate 304 with a first central opening 306 extending through the first plate 304 and having a first plurality of through holes 308 and a plurality of threaded holes (not shown) spaced in between the through holes 308. The base assembly 302 also comprises a second base plate 310 which has a second central opening 312 that extends through the second base plate 310. Referring to FIG. 5, the second base plate 310 also includes a recessed portion 314, which extends a depth into the second base plate 310 and also has a second plurality of through holes 316. The second plurality of through holes 316 align with the first plurality of through holes 308 and the plurality of threaded holes. A portion of the second plurality of through holes 316 are used with the plurality of threaded holes and a first plurality of fasteners 318 to secure the first base 304 to the second base plate 310.

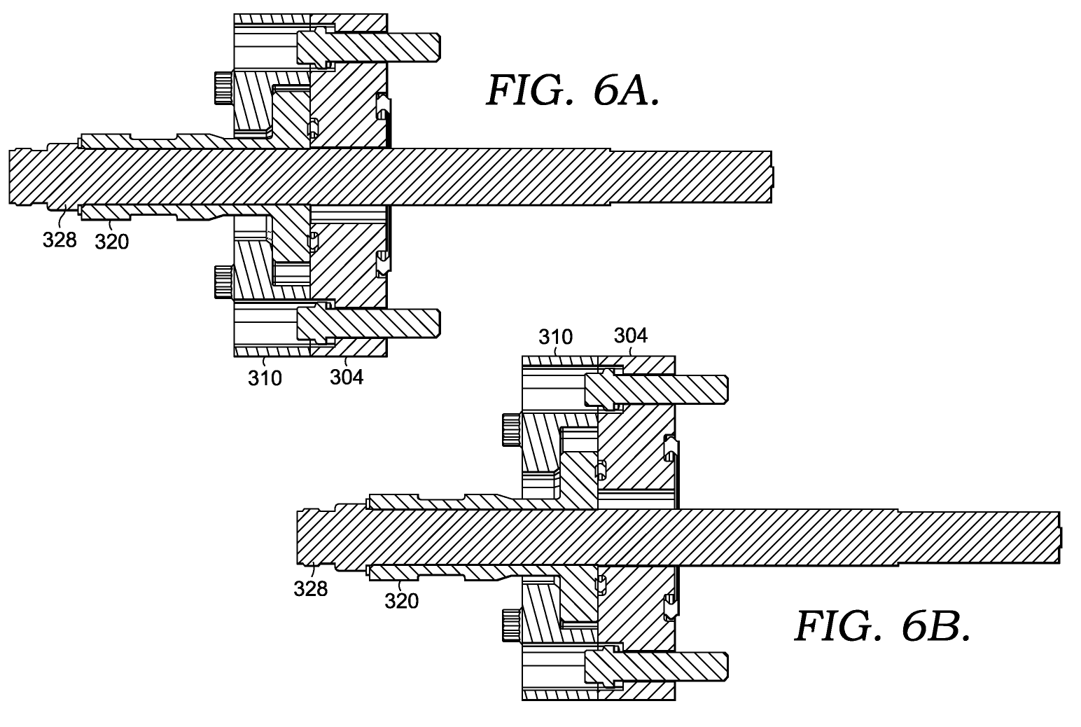

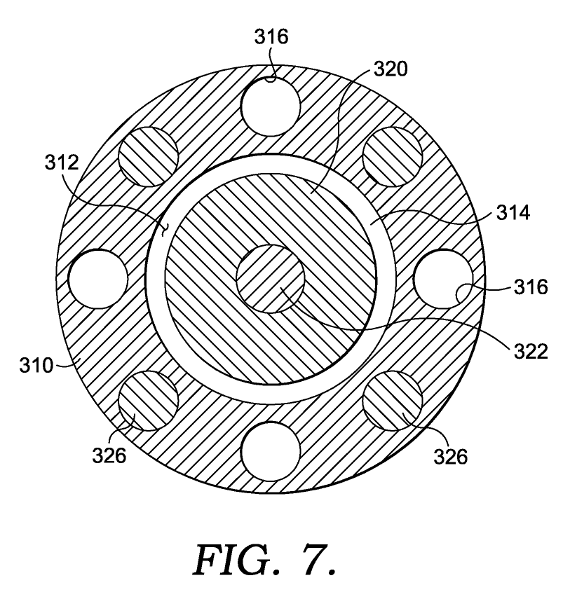

The base assembly 302 also comprises a positioning plate 320 having a third central opening 322 extending therethrough. The positioning plate 320 is located generally within the recessed portion 314 of the second base plate 310 and extends through the second central opening 312 opposite of the first base plate 304. Referring to FIGS. 6A, 6B, and 7, the recessed portion 314 is oversized compared to the positioning plate 320 such that the positioning plate 320 is capable of being repositioned within the recessed portion 314 to ensure that the ignition source does not contact a wall of the combustor 360. For an embodiment of the present invention, the recessed portion 314 of the second central opening 312 is circular in shape for containing a circularly-shaped positioning plate 320. The shape of the recessed portion 314 and positioning plate 320 can vary depending on the geometry of the igniter base assembly 302. The diameter of the positioning plate 320 is undersized by approximately 0.400 inches compared to the recessed portion 314. In FIG. 7, the positioning plate 320 is shown in a nominal position within the recessed portion 314, such that the clearance between the positioning plate 320 and sidewalls of the recessed portion 314 is approximately 0.200 inches around the entire perimeter of the positioning plate 320. This difference in relative diameters permits movement of the positioning plate 320 in any direction up to approximately 0.200 inches.

Referring back to FIGS. 4 and 5, one or more sealing gaskets 324 are in contact with the first base plate 304. The one or more sealing gaskets 324 are located in grooves 330 of the first base plate 304. The grooves 330 and the sealing gaskets 324 are located along opposing faces of the first base plate 304 such that a sealing gasket 324 is positioned between the positioning plate 320 and first base plate 304 and is compressed by the tightening of fasteners 318 so as to close off a potential leakage path from the combustor 360 through the base assembly 302. A second sealing gasket 324 is located along a surface of the first base plate 304 that mates to a combustor case 350 to provide a seal between the base assembly 302 and the combustor 360.

The base assembly 302 is secured to a combustor case 350 by a second plurality of fasteners 326, which pass through a second plurality of through holes 316 in the second base plate 310 and a first plurality of through holes 308 in the first base plate 304. In the embodiment of the present invention, four fasteners 326 are used to secure the base assembly 302 to a combustor case 350.

The ignition system 300 also includes an ignition source 328 that provides a means for igniting a combustible fuel-air mixture in the combustor. The ignition source 328 depicted in FIGS. 4 and 5 is a spark igniter, but can also be an alternate ignition source such as a torch igniter. In the embodiment of the spark igniter, the ignition source 328 is coupled to a power source (not shown) for supplying power necessary to generate the spark. The ignition source 328 is coupled to the mounting plate 320 to prevent the ignition source 328 from moving once the mounting plate 320 is locked into place by the second base plate 310 being fastened to the first base plate 304. Depending on the desired height adjustability and type of ignition source 328, the ignition source can be threaded to the positioning plate 320 or locked to the positioning plate using a Swagelok™ fitting. Referring again to FIG. 5, the depth to which the ignition source 328 extends towards and into a combustor 360 can be adjusted by placing one or more spacers 332 between the ignition source 328 and the positioning plate 320.

The openings in the first base plate 304, second base plate 310, and positioning plate 320 are all sized according to permit the ignition source 328 to pass therethrough and for relative movement of the positioning plate 320 within the recessed portion 314. As such, for the embodiment of the present invention shown in FIGS. 4 and 5, the first central opening 306 has a diameter that is greater than a diameter of the third central opening 322. Also, the second central opening 312 has a diameter that is greater than the diameter of the second central opening in order to permit the desired movement of the positioning plate 320.

Referring to FIGS. 5-7, in an alternate embodiment of the present invention, a method of adjusting an igniter 328 relative to a combustor 360 is disclosed in which the igniter 328 (also referred to as the ignition source) is placed through the positioning plate 320 of the base assembly 302 and into the combustor 360. A determination is then made as to the first position of the igniter 328 relative to a port or opening 362 on the combustor 360. Upon determination that adjustment of the igniter 328 is necessary relative to the combustor 360, the fasteners 308 which secure the second base plate 310 to the first base plate 304 are loosened to permit movement of the positioning plate 320. The second base plate 310 can be removed altogether or separated slightly from the positioning plate 320 and the first base plate 304. The positioning plate 320 is then moved in an axial and/or circumferential direction to a second position. Examples of relative movement of the positioning plate 320 are shown in FIGS. 6A and 6B. Then, a determination is made as to whether the second position of the igniter 328 in the combustor 360 is satisfactory. Once the igniter 328 is in a satisfactory position, the fasteners 308 are tightened such that the second base plate 310 is secured to first base plate 304 to lock the positioning plate 320 in the second position.

In addition to an axial and/or circumferential movement of the positioning plate 320, the radial position of the igniter within the combustor 360 can be adjusted, as previously discussed. A determination of a first depth of the igniter 328 in the combustor 360 is made and then the igniter 328 is uncoupled from the positioning plate 320. This can require either unlocking the igniter 328 or unthreading the igniter 328, depending on the igniter design. Then, depending on the desired radial position of the igniter 328, one or more washers 332 are either added to or removed from a surface between the positioning plate 320 and the igniter 328, as shown in FIG. 5. Once the one or more washers are added to or removed from the igniter assembly 300, the igniter 328 is inserted through the positioning plate 320 and into the combustor 360 to a second depth, which when washers are added is less than the first depth, but if washers are removed, is a greater than the first depth.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. An ignition system for a gas turbine combustor comprising:
a base assembly having:
a first base plate having a first central opening therethrough and having a first plurality of through holes and a plurality of threaded holes;
a second base plate having a second central opening therethrough, a recessed portion, and a second plurality of through holes;
a positioning plate having a third central opening therethrough, the positioning plate located generally within the recessed portion of the second base plate;
one or more sealing gaskets located in contact with the first base plate;
a first plurality of fasteners for securing the first base plate to the second base plate;
a second plurality of fasteners for securing the base assembly to a combustor;
an ignition source coupled to the positioning plate; and,
a power source coupled to the ignition source;
wherein the positioning plate is capable of being repositioned to ensure that the ignition source does not contact a wall of the combustor.

2. The ignition system of claim 1, wherein a diameter of the first central opening is greater than a diameter of the third central opening.

3. The ignition system of claim 1, wherein the recessed portion has a diameter greater than a diameter of the positioning plate so as to permit movement of the positioning plate in a planar direction up to approximately 0.200 inches.

4. The ignition system of claim 1, wherein a diameter of the third central opening is less than a diameter of the second central opening.

5. The ignition system of claim 1, wherein the first base plate has grooves on opposing faces capable of receiving the sealing gaskets.

6. The ignition system of claim 1, wherein the ignition source is threaded to the positioning plate.

7. The ignition system of claim 1, wherein the ignition source is locked to the positioning plate by a fitting.

8. The ignition system of claim 1 further comprising one or more spacers positioned between the ignition source and the positioning plate for adjusting a depth which the ignition source extends into the combustor.

9. The ignition system of claim 1 being a spark igniter.

10. An adjustable igniter base comprising:
a first base plate having a first central opening located therethrough and having a first plurality of through holes and a plurality of threaded holes;
a second base plate having a second central opening therethrough, a recessed portion, a positioning plate, and a second plurality of through holes;
one or more sealing gaskets; and,
a first plurality of fasteners for securing the first base plate to the second base plate;
wherein the positioning plate is capable of movement in a plane established by the recessed portion so as to adjust a location of the positioning plate relative to the first and second central openings.

11. The adjustable igniter base of claim 9, wherein the base is capable of being mounted to a combustor case.

12. The adjustable igniter base of claim 9, wherein the positioning plate has a first diameter and the recessed portion has a second diameter.

13. The adjustable igniter base of claim 12, wherein the second diameter is greater than the first diameter so as to allow the positioning plate to translate in a planar direction within the recessed portion.

14. The adjustable igniter base of claim 9 further comprising an ignition source extending through the mounting plate, first base plate, and second base plate.

15. A method of adjusting an igniter relative to a combustor comprising:
placing an igniter through a positioning plate of a base assembly and into the combustor;
determining a first position of the igniter relative to a port on the combustor;
loosening fasteners which secure a second base plate to a first base plate;
moving the positioning plate and igniter in an axial and/or circumferential direction to a second position;
determining whether the second position of the igniter is satisfactory in the combustor; and,
tightening the second base plate to the first base plate to secure the positioning plate and igniter in the second position.

16. The method of claim 14, wherein a port of the combustor is an opening in a wall of the combustor.

17. The method of claim 14 wherein the positioning plate is moved relative to the second plate.

18. The method of claim 14 further comprising:
determining a first depth of the igniter in the combustor;
uncoupling the igniter from the positioning plate;
placing one or more washers at an end of the positioning plate;
inserting the igniter through the positioning plate and into the combustor to a second depth, which is less than the first depth.

19. The method of claim 14 further comprising:
determining a first depth of the igniter in the combustor;
uncoupling the igniter from the positioning plate;
removing one or more washers from an end of the positioning plate;
inserting the igniter through the positioning plate and into the combustor to a second depth, which is greater than the first depth.
